(19) United States
(12) Patent Application Publication
(10) Pub. No.: US 2016/0304410 A1
(43) Pub. Date: Oct. 20, 2016

(54) COATINGS AND ADDITIVES CONTAINING FATTY ACIDS, SALTS OF FATTY ACIDS, OR SIMILAR COMPOUNDS, FOR USE AS DE-DUST AND/OR ANTI-CAKING AGENTS FOR GRANULAR PRODUCTS

(71) Applicant: The Mosaic Company, Plymouth, MN (US)

(72) Inventors: Murray Schultz, Moose Jaw (CA); Crystal Laschilier, Regina (CA); Russell Adams, Briercrest (CA); Jarid Hancock, Regina (CA); Michelle Johnson, Regina (CA); Kathlene Laurie Jacobson, Saskatoon (CA); Dawne Fuchs, Bethune (CA); Kimberly Rinas, Regina (CA)

(21) Appl. No.: 15/131,328

(22) Filed: Apr. 18, 2016

Related U.S. Application Data
(60) Provisional application No. 62/148,537, filed on Apr. 16, 2015.
(60) Provisional application No. 62/217,407, filed on Sep. 11, 2015.

(51) Int. Cl. C05G 3/00; B01J 2/30

(52) U.S. Cl. CPC C05G 3/0088; C05G 3/0041; B01J 2/30

(57) ABSTRACT

Coatings and additives including a fatty acid or salt of fatty acid for application to granules. The coatings or additives can be applied to granules of, for example, fertilizer or animal feed. The fatty acid can be stearic acid, another saturated fatty acid, a salt of fatty acid such as sodium stearate, or combinations thereof, and can optionally include a carrier fluid. Preferably, the coating or flow additive is animal feed-grade certified to be used for products incorporated into food or animal feed as a nutrient supplement.

### RELATED APPLICATIONS

The present application claims the benefit of U.S. Provisional Application No. 62/148,537 filed Apr. 16, 2015 and U.S. Provisional Application No. 62/217,407 filed Sep. 11, 2015, each of which is hereby incorporated herein in its entirety by reference.

### TECHNICAL FIELD

Embodiments are directed to dust control coatings and flow additives for reducing the dust generated in the production, transport, and application of granulated fertilizer, as well as for anti-caking and degradation reduction or prevention. Specifically, in embodiments, these coatings can comprise long-chain fatty acids such as stearic acid.

### BACKGROUND

Inorganic agriculturally beneficial materials, such as fertilizers, typically include a granular base comprising at least one of three primary inorganic nutrients—nitrogen (N), phosphate (P), and potassium (K). These fertilizers are identified by their NPK rating in which the N value is the percentage of elemental nitrogen by weight in the fertilizer, and the P and K values represent the amount of oxide in the form of P₂O₅ and K₂O that would be present in the fertilizer if all the elemental phosphorus and potassium were oxidized into these forms. The N—P—K proportions or concentration vary across fertilizer types and user needs.

For example, the base fertilizer can comprise a phosphate fertilizer (such as monoammonium phosphate (“MAP”), diammonium phosphate (“DAP”)), a potash fertilizer (such as muriate of potash (“MOP”) or potassium chloride (“KCl”)) or other potassium-based fertilizer, or a nitrogen-based fertilizer such as a fertilizer containing urea. The fertilizers can also include any combination of secondary nutrients and/or micronutrients. The secondary nutrients can include sulfur compounds, calcium, and/or magnesium, and the micronutrients can include iron, manganese, zinc, copper, boron, molybdenum, and/or chlorine. The micronutrients and/or secondary nutrients can be added to solution in their elemental form, or as compounds, such as a salt.

Many of these agricultural products are granulated, dried, and treated with dust control agents after formulation to provide the fertilizer in a stable and easily handled form. An inherent drawback of the conventional granulation process is that a significant portion of the product may generate dust particulates either during manufacture, storage, or in distribution, which is significantly more difficult to handle and distribute on the fields to be treated. In addition to wasting otherwise useful product, the granules may create undesirable fugitive particle emissions. Fugitive particulate emissions can be mitigated, but in certain conditions mitigation costs can become uneconomical.

To reduce dust generation, the granules are often coated with an anti-dust coating that reduces or entraps the dust created during the granulation or transport. The anti-dust coating can comprise, for example, petroleum, wax, or other oil-based liquids that are sprayed onto the granules to adhere any dust particulates formed, during granulation or transport, for example, to the larger granules. The coating also encapsulates the dust particulates to prevent or inhibit the dust particulates from becoming airborne.

While traditional coatings are effective at controlling the dust particulates, the inherent drawback of these coatings is that the coatings have a limited effective shelf-life and can have diminishing effectiveness as the coating ages. Prolonged storage or transport of the coated granules can present a greater safety risk as the storage or transport time may have exceeded the effective life of the coating resulting in unsafe products, and/or undesirable flow characteristics in storage bins, transportation equipment, processing equipment, and field application equipment. Furthermore, these traditional coatings can potentially add significant cost to the end-product due to the cost of the coating composition and/or increased manufacturing costs. Alternative de-dusting agents with extended shelf life are commercially available but these products tend to have substantially higher cost and for this reason have not been broadly adopted by the industry.

With respect to potassium chloride or KCl specifically, KCl is used in a number of industries in addition to agriculture, such as, for example, food processing, chemical processing, and medicine. Most commonly, KCl, such as muriate of potash or MOP, is used for making potassium fertilizers as potassium is an essential plant nutrient and is required in large amounts for proper growth and reproduction of plants. As a chemical feedstock, it is used for the manufacture of potassium hydroxide and potassium metal.

With respect to the food industry, potassium chloride can be used as a nutrient or potassium supplement, or as a sodium-free substitute for table salt. More particularly, feed-grade potassium chloride is a source of highly available potassium and chloride, which help meet livestock and poultry essential nutrient requirements. For example, commercially available Dyna-K®, available from the applicant of the present invention, is a rich source of potassium in readily available chloride form. It provides vital potassium, which is essential for maximum activity of rumen microbes. Potassium is critical for animals to maintain homeostasis and the health of cells at a cellular level.

Due to the inherent hydroscopic properties of potassium-based products and particularly potassium chloride, the individual granules or particulates tend to cake to one another forming agglomerates, thereby affecting the ability of the granules to free-flow. This can be particularly problematic when used in processes incorporating automated metering equipment, such as hoppers. Caking tendencies of the products can be accelerated during shipping and/or transport. For example, pressure is exerted on the product for extended time periods during shipping and/or transport. Furthermore, increased or variations in temperature and relative humidity can also contributed to caking tendencies.

As such, there is a need for a means of efficiently and effectively reducing dust generated and/or reducing caking tendencies during the handling of granular materials, such as fertilizers or other granular agricultural products, while maintaining or increasing the agricultural benefits of the granular agricultural products.

### SUMMARY

According to embodiments, a de-dusting and/or anti-caking coating or additive is generally formed from a composition comprising a long-chain fatty acid, salt of fatty acid, and/or similar materials adapted to be applied to particulate agricultural products, such as, for example, standard, fine, or crystal granular fertilizers, turf feed granules, animal feed pellets, or any of a variety of particular agricultural products.

In one embodiment, the fatty acid material comprises a saturated fatty acid, and more particularly, an 18-carbon chain saturated fatty acid, and even more particularly, stearic acid. The fatty acid can be melted or otherwise provided as a flowable or fluid form, and applied directly to the granules, such as by spraying. Alternatively, the fatty acid can be melted into a carrier fluid, such as an oil or oil-based material, and can subsequently be applied to the granules, such as by spraying.

According to another embodiment, a method comprises melting a fatty acid, including optionally melting the fatty acid into a carrier fluid, applying the composition to a plurality of granules, and drying the granules, thereby leaving a coating of the fatty acid covering at least a portion of each individual granule.

According to yet another embodiment, free-flowing potassium (K) agricultural, fertilizer, or other products, such as KCl, incorporates a flow additive for preventing or reducing caking tendencies and maintaining or enhancing free-flow characteristics of the product, even during extended periods of transport and/or storage, and regardless of high relative humidity environments or variations in temperature. Preferably, the flow additive is animal feed-grade certified to be used for products incorporated into food or animal feed as a potassium supplement. In one aspect, the flow additive comprises sodium stearate or sodium salt of fatty acid (C₁₈H₃₅NaO₂). Sodium stearate is a feed-certified flow additive that has both hydrophilic and hydrophobic parts, the carboxylate and the long hydrocarbon chain, respectively. These two chemically different components induce the formation of micelles, which present the hydrophilic heads inwardly and their hydrophobic (hydrocarbon) tails outwardly so as to create a hydrophobic exterior surface to repel water or moisture from the surface, thereby preventing or reducing set-up or bridging of individual granules to ensure that the granules remain free-flowing.

In an embodiment, the flow additive is added to the potassium fertilizer product as a dry powder in an amount of from about 0.5 lb stearate to ton of fertilizer (lb/ton) to about 10 lb/ton, and more particularly in an amount from about 1.5 lb/ton to about 5 lb/ton. Upon addition of the flow additive, the hydrophilic heads of the stearate are attracted to the hydroscopic surface of the potassium chloride granules causing a substantial coating of the granules with the additive, with the hydrophobic tails aligned radially outwardly from the surface of the granules.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

Subject matter hereof may be more completely understood in consideration of the following detailed description of various embodiments in connection with the accompanying figures, in which:

FIG. 1 depicts an untreated white, fine-size potassium chloride product of the prior art.

FIG. 2 depicts the white, fine-size potassium chloride product of FIG. 1 treated with 3.0 lb/ton flow additive.

FIG. 3 depicts a red, standard-size potassium chloride product treated with 2.5 lb/ton flow additive after exposure to 85% relative humidity and temperature of 40 degrees C.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

According to embodiments, a de-dusting and/or anti-caking coating or additive is generally formed from a composition comprising a long-chain fatty acid, salt of fatty acid, and/or similar materials adapted to be applied to particulate agricultural products. According to some embodiments, a de-dust composition comprises a de-dust component such as stearic acid, other saturated or unsaturated fatty acids, a salt thereof or combinations thereof, and optionally a carrier fluid such as an oil. The de-dust composition can be applied to granules forming a coating over at least a portion of an exterior or outer surface of the granules. The coating can aid in reducing the amount of dust generated by the granules during production, storage, handling, transport, and application.

The de-dust composition can be applied to any of a variety of granule types, including agricultural products such as, for example, standard, fine, and crystal granular fertilizers, animal feed pellets, turf builder or feed granules, and the like. For example, the de-dust composition can be applied to a potassium chloride fertilizer, such as PEGASUS® fertilizer, or a phosphate fertilizer, such as MICROESSENTIALS® fertilizer, both of which are commercially available from The Mosaic Company.

In one embodiment, the de-dust component comprises stearic acid (C₁₈H₃₆O₂). The stearic acid can comprise a commercially available stearic acid, available in a variety of grades such as, for example, pharmaceutical grade, cosmetic grade, feed grade, food grade, medicine grade, and tech grade, having varying purities. In various alternative embodiments, other long chain saturated and/or unsaturated fatty acids can be used as an alternative to or in combination with stearic acid. For example, the fatty acid could be some other saturated fatty acid with a melting point similar to that of stearic acid. In embodiments, the carbon chain length of the saturated fatty acid can be between, for example, 10 and 25 carbon atoms. In other embodiments, a blend of fatty acids can be used, having a range of carbon chain lengths and/or melting points.

In an embodiment, the de-dust component is melted into or otherwise combined with a carrier fluid and the resulting composition is applied to the fertilizer granules. In an alternative embodiment, the de-dust component is directly applied to the granules directly, without a carrier fluid.

More particularly, in a first embodiment, the de-dust component can be applied directly to a fertilizer granule, without a carrier fluid. In this embodiment, the de-dust component is heated and maintained at or above its melting temperature until it is melted or flows. For example, for stearic acid, the stearic acid is heated and maintained to or above its melting point of about 69.3 degrees Celsius.

In a second embodiment, the de-dust component is combined with a suitable carrier fluid. A suitable carrier fluid can be any fluid into which the stearic acid or other fatty acid component is at least partially soluble. For example, the carrier fluid can comprise an oil, such as mineral oil or castor oil. The ratio of de-dust component and oil can be selected in order to achieve a desired level of dust prevention. Furthermore, the use of a particular oil can be chosen to tailor certain characteristics of the coated granule, such as hydrophobic or hydrophilic properties, coating thickness, or the like. The de-dust component and carrier fluid can be combined by heating and melting the de-dust component and then combining it with the carrier fluid, heating the carrier fluid to melt the de-dust component therein, or a combination of the two.

In embodiments, the de-dust component can be present in an amount of about 0.1 to about 100 percent by weight of the total de-dust composition, and more particularly from about 0.1 to about 50 percent by weight of the total de-dust composition. For example, when 100 percent by weight, the de-dust component can comprise a pure fatty acid.

The hot or molten de-dust composition (with or without a carrier fluid) is then applied to the granules, such as by spraying, curtain coating, tumbling, or any of a variety of suitable application techniques or the like. The granules are then cooled/dried so that the de-dust composition no longer flows, and has formed a de-dust coating, such as a continuous or substantially continuous coating over an exterior surface of the granule. In embodiments, the coating makes up from about 0.01 to about 5 weight percent of the entire granule, more particularly from about 0.1 to about 1 weight percent, and more particularly 0.5 weight percent. In embodiments, the coating can have a thickness of from about 0.1 to about 10 μm.

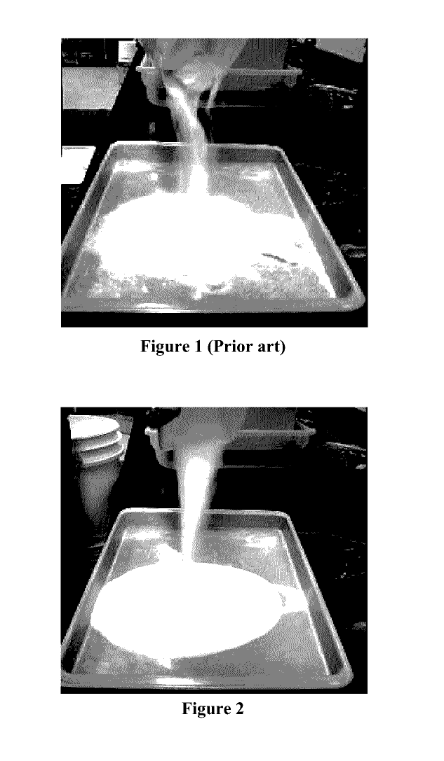

According to another embodiment, and referring to FIG. 1, granular potassium chloride, such as an untreated white or red potassium chloride fertilizer in any of an unlimited variety of particle sizes (e.g. soluble, fine, standard, coarse, extra coarse, granular), exhibits caking tendencies when stored and/or transported. In embodiments, particle sizes can range from about 0.01 mm to about 5.0 mm, and can have an unlimited variety of particle size distributions (e.g. based on Tyler mesh or sieve analysis), and/or particle size distribution corresponding to commercially available grades such as soluble, fine, standard, coarse, granular, extra coarse, etc. As discussed above, due to the hydroscopic nature of the potassium chloride fertilizer, caking is induced and the granules agglomerate, forming clumps. This can make the product difficult to use, particularly in automated metering equipment such as hoppers and the like. In the worst case scenario, the product is unusable.

To alleviate the caking tendencies, a flow additive is added to the potassium chloride fertilizer (or other potassium products or fertilizers). In one embodiment, the flow additive comprises an animal-feed certified sodium stearate (sodium salt of fatty acid). In an alternative embodiment, other metal or mineral salts of fatty acids can be used, such as, for example, zinc stearate, calcium stearate, magnesium stearate, or any combination thereof. In certain embodiments, the mineral or metal salt provides a secondary nutrient or micronutrient source, when used as a fertilizer or animal feed supplement.

In embodiments, the flow additive can be added to the fertilizer product as a dry powder an amount of from about 0.5 lb stearate to ton of fertilizer (lb/ton) to about 10 lb/ton, and more particularly in an amount from about 1.5 lb/ton to about 5 lb/ton. The flow additive is blended with the fertilizer product via any number of mixing mechanisms, such as, for example, ribbon blenders or baffles. In alternative embodiments, the stearate can be dispersed in a carrier, such as water and/or oil (food grade or otherwise), and sprayed or otherwise applied to an outer surface of the granules. Optionally, the carrier is driven off or removed such as by evaporation, leaving a continuous or discontinuous stearate coating on each granule.

In yet another embodiment, the flow additive (as a dry powder or dispersion) can be added as part of a two-stage treatment. For example, the flow additive can be added before and/or after a liquid treatment is applied, such as the application of water or oil to the outer surface of the granule. This aids in securing, such as by adhesion or encapsulation, of the flow additive to the outer surface of the granule.

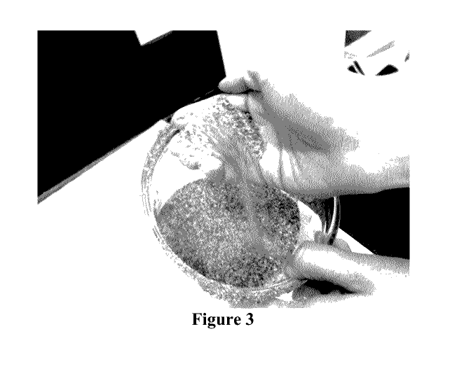

In one example and referring to FIG. 2, a white potassium chloride is treated with 3.0 lb/ton of animal-feed certified sodium stearate (sodium salt of fatty acid) dry powder.

In another example and referring to FIG. 3, a red potassium chloride is treated with 2.5 lb/ton of animal-feed certified sodium stearate dry powder.

The example products of FIGS. 2 and 3 were then tested for flowability. To test the products, pressure is exerted on the product to induce caking and simulate conditions that may exist in storage and shipping. The tests are performed on potassium fertilizers at varying temperatures and humidity levels. For both examples, it was observed that the addition of sodium stearate powder is superior in regards to anti-caking performance under all conditions, including high levels of relative humidity (85%+) relative to the untreated fertilizer of FIG. 1. Furthermore, the sodium stearate significantly out-performed other anti-caking additives, particularly those added through an oil medium, as the treated products remained free-flowing in all conditions with little to no caking observed.

The coatings and additives according to embodiments can result in reduced dusting, attrition, and/or caking of the granular product, and may also enhance other granule product quality metrics such as dissolution rates, environmental stability, anticaking properties, degradation reduction or prevention, and/or the like. In a particular embodiment with respect to fertilizer granules, the coatings and additives ensure adequate dust control and anti-caking, without inhibiting release of the fertilizer's nutrients to the soil, once applied. In other words, they do not act as a timed-release or slow-release coating.

The use of long-chain fatty acids, such as stearic acid, in a coating or additive composition can enhance quality of the coated granules beyond the levels possible with conventional coatings, without significantly increasing the cost of production. The fatty acid de-dust coating can also be substantially safer, both to people and the environment, than conventionally used de-dust coatings, such as amine-based coatings.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

What is claimed is:

1. An agricultural product comprising:
a plurality of agriculturally beneficial granules; and
an additive comprising a fatty acid component.

2. The product of claim 1, wherein the fatty acid component comprises a salt of fatty acid selected from the group consisting of sodium stearate, calcium stearate, magnesium stearate, zinc stearate, and combinations thereof.

3. The product of claim 2, wherein the salt of fatty acid comprises sodium stearate.

4. The product of claim 1, wherein the fatty acid component comprises a saturated fatty acid.

5. The product of claim 4, wherein the saturated fatty acid is stearic acid.

6. The product of claim 1, wherein the fatty acid component comprises a blend of fatty acids.

7. The product of claim 1, further comprising a carrier fluid, wherein the fatty acid component is dispersed within the carrier fluid.

8. The product of claim 7, wherein the carrier fluid is an oil.

9. The product of claim 1, wherein the fatty acid component is present in an amount in a range of from about 0.01 to about 5 weight percent of the product.

10. The product of claim 1, wherein the fatty acid component is added to the granules as a dry powder blended therewith.

11. The product of claim 11, wherein the dry powder is added in an amount of from about 0.5 lb to about 10 lb dry powder to ton of granules (lb/ton).

12. The product of claim 1, wherein the fatty acid component forms a coating over the granules.

13. The product of claim 1, wherein the coating has a thickness of from about 0.1 to about 10 μm.

14. A method of reducing or preventing caking of a granular product, the method comprising:
providing a plurality of granules; and
adding a flow additive to the granules, the flow additive comprising a salt of fatty acid.

15. The method of claim 14, wherein the salt of fatty acid is selected from the group consisting of sodium stearate, calcium stearate, magnesium stearate, zinc stearate, and combinations thereof.

16. The method of claim 15, wherein the salt of fatty acid comprises sodium stearate.

17. The method of claim 14, wherein the flow additive is added to the granules as a dry powder blended therewith.

18. The method of claim 14, wherein the flow additive is added in an amount of from about 0.1 lb of flow additive per ton of granules (lb/ton) to about 10 lb/ton.

19. The method of claim 18, wherein the flow additive is added in an amount of from about 1.5 lb/ton to about 5.0 lb/ton.

20. The method of claim 14, wherein the flow additive is added to the granules by dispersing the flow additive in a carrier, applying the carrier to the granules, and optionally removing the carrier therefrom.

21. The method of claim 14, wherein the flow additive is added to the granules in two stages, the two stages comprising:
treating an exterior surface of the granules with a liquid treatment;
applying the flow additive to the exterior surface of the granules after the liquid treatment.

22. The method of claim 21, wherein the liquid treatment comprises applying oil to the exterior surface of the granules.

23. The method of claim 14, wherein the plurality of granules comprises potassium chloride granules.

24. A method of treating granules with a de-dusting and/or anti-caking composition, the method comprising:
melting a fatty acid component; and
coating a plurality of granules with the fatty acid component and optional carrier to form a coating on each of the granules.

25. The method of claim 24, further comprising combining the fatty acid component with an oil carrier after melting the fatty acid component.

26. The method of claim 24, wherein the fatty acid comprises stearic acid.

27. The method of claim 24, wherein coating the granule comprises spraying the granules with the fatty acid component and optional carrier.

28. The method of claim 27, further comprising, when a carrier is present, driving off substantially an entirety of the carrier after coating.

29. The method of claim 24, wherein the fatty acid component is present in an amount in a range of from about 0.01 to about 5 weight percent based on a total weight percent of each coated granule.

30. The method of claim 24, wherein the coating has a thickness of from about 0.1 to about 10 μm.
